(19) United States
(12) Patent Application Publication
(10) Pub. No.: US 2002/0075678 A1
(43) Pub. Date: Jun. 20, 2002

(54) Method and device for generating white light by two types of diode chips

(76) Inventor: Ming-Shun Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/737,745

(22) Filed: Dec. 18, 2000

(51) Int. Cl. F21V 9/00

(52) U.S. Cl. 362/231; 362/249; 362/800

(57) ABSTRACT

A device for generating white light using two types of diode chips includes first, second and third pins that each have a first end and a second end. An illuminant unit has a first diode chip to emit blue light and a second diode chip to emit greenish yellow light. The first diode chip is electrically connected between the first ends of the first and second pins, and the second diode chip is electrically connected between the first ends of the second and third pins. In addition, a packing of white resin is used to enclose the diode chips and the first ends of the pins.

### BACKGROUND OF THE INVENTION

1. Field of the Invention

The present invention relates to a method and a device for emitting white light and, more particularly, to a method and a device for emitting white light by two types of diode chips.

2. Description of Related Art

Light emitting diodes (LEDs) that emit light in true color are known. In general, such an LED includes three diode chips that emit red, green and blue lights respectively before they are optically mixed up. White light is obtained when the three types of light are equal in their intensities. Theoretically, white light can also be composed by two lights in different colors, such as in blue and greenish yellow, which is to be proved hereinafter.

FIG. 7 shows a chromaticity diagram of CIE system, in which the surrounded area represents all colors in existence. The points near the boundary stands for colors of higher saturation, including saturated red, orange, yellow, greenish yellow, green, blue and violet or purple, the points away from the boundary for colors of lower saturation, and points in the central area for the white color.

According to the X-Y coordinates, the saturated color of greenish yellow is positioned at a point about (0.47, 0.53) and that of blue at a point about (0.12, 0.07). Provided the two points are linked, the straight linking line will surely run through the central area standing for the white color. In other words, it has been shown that white light is obtainable from two diode chips that emits differently colored lights.

Therefore, it is an objective of the invention to provide a method and a device for emitting white light by two types of diode chips.

### SUMMARY OF THE INVENTION

The object of the present invention is to provide a method for emitting white light by LED(s) having only two diode chips.

Another object of the present invention is to provide a device for emitting white light by LED(s) having only two diode chips.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing a printed circuit included in a first embodiment of a device in accordance with the present invention;

FIG. 2 is a perspective view showing one of illuminant units included in the first embodiment of the device;

FIG. 3 is a connecting diagram of the illuminant units;

FIG. 4 is a view showing the first embodiment of the device configured as a display device;

FIG. 5 is a view of the device of FIG. 4, with an encoder and a pair of transistors electrically connected thereto;

FIG. 6 is a cross sectional view showing a second embodiment of the device, in accordance with the present invention, configured as an LED; and

FIG. 7 is a chromaticity diagram of CIE system.

### DETAILED DESCRIPTION OF THE PREFERRED EMBODIMENT

The figures show preferred embodiments of a method and a device in accordance with the present invention for generating white light by two types of diode chips.

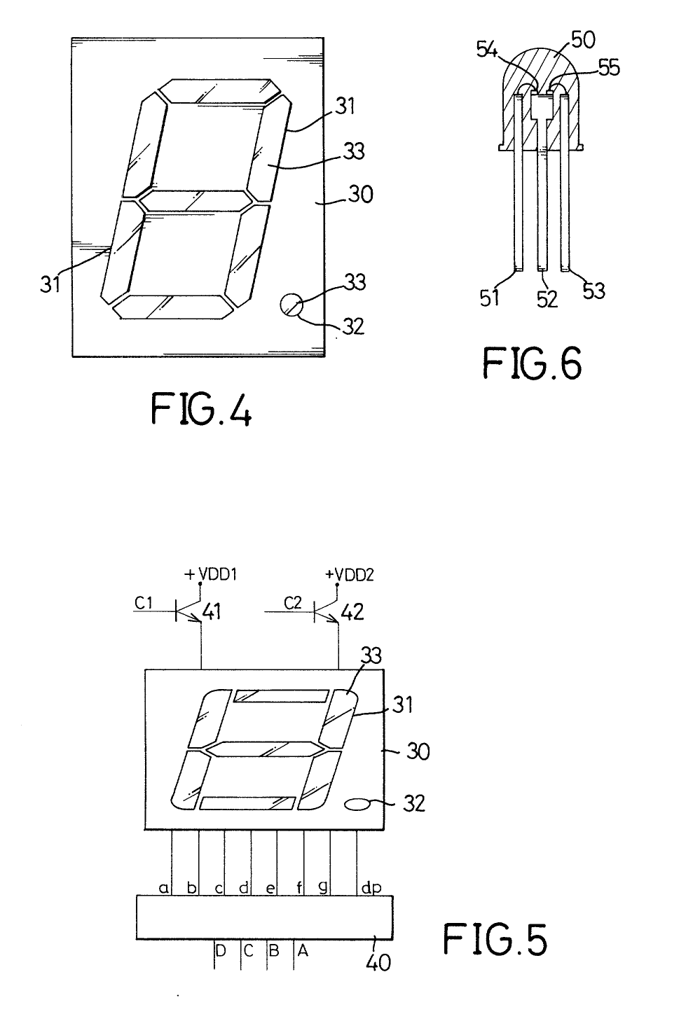

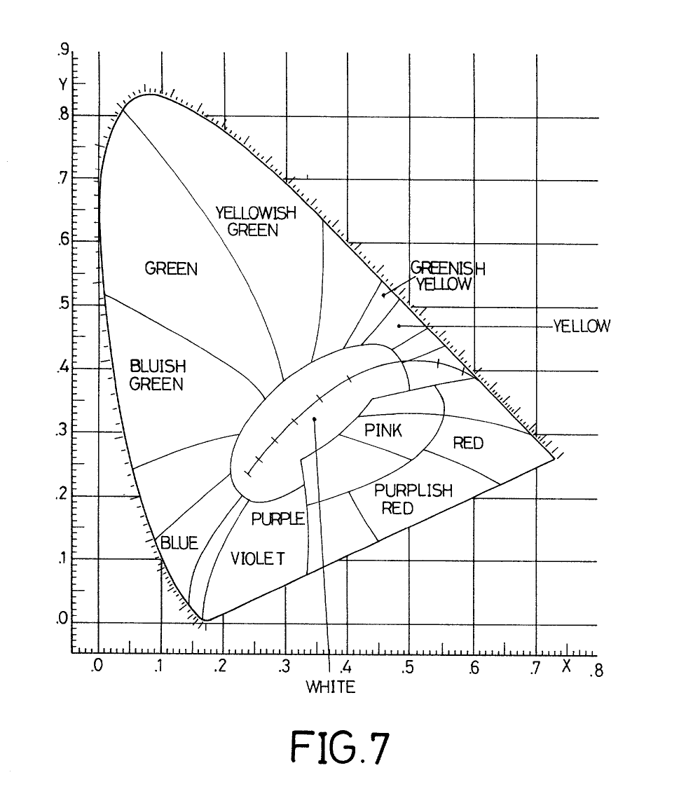

Referring to FIG. 4, a first embodiment of the inventive device is configured as a display device for a variable pattern, such as one including a decimal number and, optionally, a decimal point.

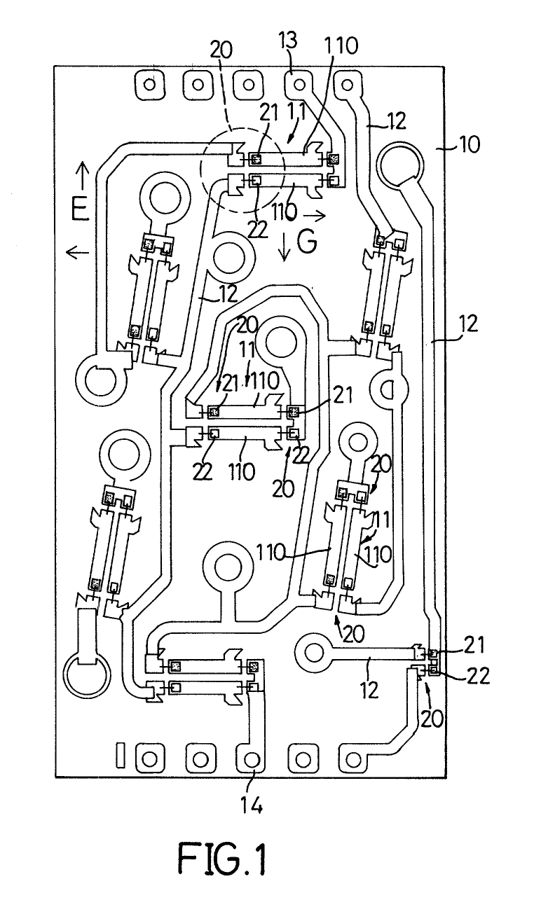

Referring to FIG. 1, the display device includes a circuit board (10) having a plurality of foil archipelagoes (11) and a plurality of foil links (12) associated with the archipelagoes (11). It can be found -that the foil archipelagoes (11) are arranged on the board (10) in an arrangement like an Arabian number of 8, and each have a pair of parallel foil islands (110). The foil links (12) have nodes adjacent to respective ends of the foil islands (110).

Electrically connected between the ends of the foil islands (110) and the nodes of the foil links (12) are a plurality of illuminant units (20), each having a first diode chip (21), such as of the type C430-CB290, that emits blue light, and a second diode chip (22), such as of the type ULC-0570 or TK-112YGU, that emits greenish yellow light. The first diode chips (21) or the second diode chips (22) in connection with the same island (110) are electrically connected in series, so as to achieve an elongated illuminant one the printed board (10).

Furthermore, an additional illuminant unit (20) is located on a lower-right corner of the circuit (10), in order to serve as the decimal point for the Arabian number. However, unlike those mentioned above, this illuminant unit (20) has first and second diode chips (21, 22) that are each electrically connected between nods of two foil links (12).

Irrespective of their purpose, i.e. for displaying the decimal number or point, the units (20) are selectively supplied with electrical power by way of the printed circuit (10), to be more precious, through the foil links (12) which, as illustrated, have respective pad (13, 14) to be electrically connected to a power supply directly or indirectly.

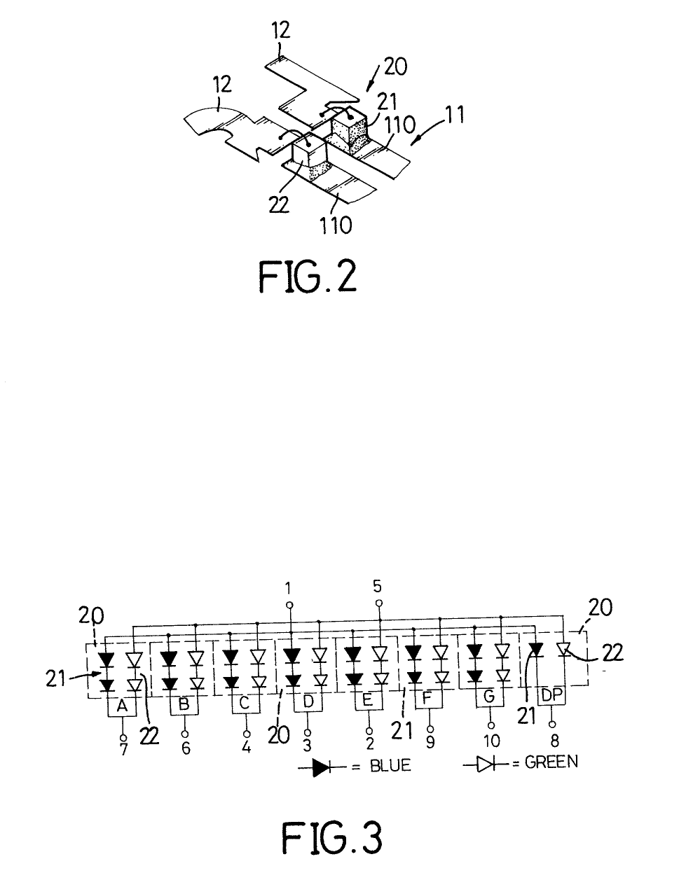

Referring to FIG. 2, the diode chips (21, 22) of each illuminant unit (20) may be electrically connected to the ends of the foil islands (110) directly, and to the nodes of the foil links (12) through either wires or flip chips. Alternatively, the diode chips (21, 22) may be electrically connected to the nodes of the foil links (12) directly, and to the ends of the foil islands (110) through either wires or flip chips.

Referring to FIG. 3, now a connecting diagram of the illuminant units (20) is shown. It can be found in the diagram that there is a first terminal (1) electrically connected to positive ends of the first diode chips (21) and a second terminal (5) electrically connected to positive ends of the second diode chips (22). The negative ends of the two chips (21, 22) in each illuminant unit (20) are electrically connected to a third terminals (2˜4, and 6˜10).

In this configuration, the two diode chips (21, 22) of each unit (20) can be lit either singly or collectively, emitting blue and/or greenish yellow light when the unit (20) is electrically energized. Optionally, each unit (20) may be electrically energized so that its two diode chips (21, 22) are lit and emit differently colored lights alternately.

Referring to FIG. 4, the display device further includes a package casing (30) that receives the printed circuit (10). The casing (30) has a plurality of elongated openings (31) for exposing the illuminant units (20) that display the decimal number, and a circular opening (32) for exposing the additional illuminant unit (20) that displays the decimal point.

Each of the openings (31, 32) is configured as a compartment that has inner walls adapted to reflect the light emitted from the illuminant unit(s) (20). Furthermore, the compartment is filled with a white optical medium, preferably a packing (33) of white resin which encloses the diode chips (21, 22). As a more preferred embodiment, the resin is made from EP700A, EP700B and D20S in the ratio of 100, 100 to 20 by weight. Because of the white optical medium, the colored lights from the diode chips (21, 22) can be optically mixed up to form white light after passing through the medium.

Referring to FIGS. 5 and additionally to FIG. 3, an encoder (40) is provided for controlling the right number the device displays. The encoder (40) has inputs (A, B, C, D), and outputs (a, b, c, d, e, f, g, dp) electrically connected to the third terminals (2˜4 and 6˜10) of the display device, as shown in FIG. 3.

Additionally, there are provided a pair of transistors (41, 42), each having a collector coupled to one of potential sources (+VDD 1,+VDD2) and a emitter coupled to one of the first and second terminals (1, 5). The transistors (41, 42) serve as a pair of switches. If the transistor (41) is switched on solely, only the first diode chips (21) of the illuminant units (20) are lit, displaying the decimal number with blue light. If the transistor (42) is switched on solely, only the second diode chips (22) of the illuminant units (20) are lit, displaying the decimal number with greenish yellow light.

However, if the transistors (41, 42) are both switched on, the first and second diode chips (21, 22) are lit, emitting differently colored lights, which are optically mixed up as they reach and pass through the white optical medium (33), thereby forming substantially white light to display the decimal number and, optionally, the decimal point.

White-like light are obtainable when the transistors (41, 42) are switched on alternately, as long as the alternation is in a high enough frequency. Each unit (20) involved is now electrically energized so that its two diode chips (21, 22) are lit alternately. Because of the high frequency of the alternation, the differently colored lights form the same unit (20) will look substantially white in color, due to the visional persistence of human's eyes, especially after the lights pass through the white optical medium (33). Thus, the decimal number and point appear to be displayed with substantially white light.

The achievement of the substantially white or white-like light necessitates the lights from the diode chips (21, 22) having rational intensities one to the other. In fact, this can be accomplished by adjusting the currents passing through the chips (21, 22) to appropriate values, preferably in the range between 8.5 mA and 11 mA.

Referring to FIG. 6, the second embodiment of the device in accordance with the present invention is configured an LED that emits white or white-like light. The inventive device here includes first, second and third pins (51, 52, 53), each having a first end and a second end.

An illuminant unit (not numbered) is formed on the first ends of the pins (51, 52, 53). The illuminant unit includes a first diode chip (54) to emit blue light, and a adjacent second diode chip (55) to emit greenish yellow light. The first diode chip (54) is designed to be electrically connected between the first ends of the first and second pins (51, 52), and the second diode chip (55) is to be electrically connected between the first ends of the second and third pins (52, 53). In the illustrated preferred embodiment, the diode chips (54, 55) are attached to the first end of the second pin (52), and are electrically connected to the first and third pins (51, 53) by way of respective wires, as clearly shown.

The diode chips (54, 55) and the first ends of the pins (51, 52, 53) are enclosed by a packing (50) of white resin, which may be made from the same ingredients as that disclosed in the above embodiment.

With this inventive device, it is clear that blue, greenish yellow, and white or white-like light can be emitted when the diode chips (54, 55) is electrically energized singly, collectively or alternately.

From the above description, it is noted that the invention has the following advantages:

1. simple structure:

Because there are only two types of diode chips, the illuminant unit is simple in structure.

2. low cost:

Because of the simple structure, the illuminant unit can be manufactured at a lower cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for generating white light, comprising the steps of:
preparing an illuminant unit (20) having a first diode chip (21) to emit blue light and an adjacent second diode chip (22) to emit greenish yellow light;
electrically energizing said illuminant unit (20) so that said first diode chip (21) emits blue light and said second diode chip (22) emits greenish yellow light;
causing each of said lights from said diode chips (21, 22) to pass at least partially through a white optical medium; and
wherein said step of electrically energizing is made so that said lights from said diode chips (21, 22) have respective intensities in such a ratio, one to the other, that the light passes through said optical medium may look substantially white in color

2. The method as claimed in claim 1, wherein said step of electrically energizing is made in such a way that said diode chips (21, 22) emit said lights alternately.

3. The method as claimed in claim 2, wherein said first diode chip (21) is of the type C430-CB290.

4. The method as claimed in claim 2, wherein said second diode chip (22) is of the type ULC-0570.

5. The method as claimed in claim 2, wherein said second diode chip (22) is of the type TK-112YGU.

6. The method as claimed in claim 2, wherein said step of electrically energizing is made so that each of said diode chops (21, 22) is supplied with a current of 8.5 mA to 11 mA.

7. The method as claimed in claim 1, wherein said optical medium is a packing (33, 50) of white resin enclosing said diode chips (21, 22).

8. The method as claimed in claim 7, wherein said white resin is made from EP700A, EP700B and D20S in the ratio of 100, 100 to 20 by weight.

9. a device for generating white light to display a pattern, comprising:
a printed circuit (10);
a plurality of illuminant units (20) arranged on said printed circuit (10) in an arrangement related to said pattern;
each of said illuminant units (20) having a first diode chip (21) to emit blue light and a second diode chip (22) to emit greenish yellow light, said diode chips (21, 22) being intended to be supplied with electrical power by way of said printed circuit (10);
a package casing (30) receiving said printed circuit (10), said package casing (30) having a plurality of openings (31) defined therein for exposing said illuminant units (20) arranged on said printed circuit board (10); and
at least one packing (33) of white resin enclosing said diode chips (21, 22) of said illuminant units (20).

10. The device as claimed in claim 9, wherein said first diode chip (21) is of the type C430-CB290.

11. The device as claimed in claim 9, wherein said second diode chip (22) is of the type ULC-0570.

12. The device as claimed in claim 9, wherein said second diode chip (22) is of the type TK-112YGU.

13. The device as claimed in claim 9, wherein each of said diode chips (21, 22) is intended to be supplied with a current of 8.5 mA to 11 mA.

14. The device as claimed in claim 9, wherein said white resin is made from EP700A, EP700B and D20S in the ratio of 100, 100 to 20 by weight.

15. A device for generating white light as a light emitting diode, comprising:
first, second and third pins (51, 52, 53) each having a first end and a second end;
an illuminant unit having a first diode chip (54) to emit blue light and a second diode chip (55) to emit greenish yellow light, said first diode chip (54) being electrically connected between said first ends of said first and second pins (51, 52), said second diode chip (55) being electricalLy connected between said first ends of said second and third pins (52, 53); and
a packing (50) of white resin enclosing said diode chips (54, 55) and said first ends of said pins (51, 52, 53).

16. The device as claimed in claim 15, wherein said first diode chip (54) is of the type C430-CB290.

17. The device as claimed in claim 15, wherein said second diode chip (55) is of the type ULC-0570.

18. The device as claimed in claim 15, wherein said second diode chip (55) is of the type TK-112YGU.

19. The device as claimed in claim 15, wherein each of diode chops (54, 55) is intended to be supplied with a current of 8.5 mA to 11 mA.

20. The device as claimed in claim 15, wherein said white resin is made from EP700A, EP700B and D20S in the ratio of 100, 100 to 20 by weight.
